(19) United States
(12) Patent Application Publication
(10) Pub. No.: US 2022/0035596 A1
(43) Pub. Date: Feb. 3, 2022

(54) Apparatuses, Methods and Computer Programs for a User Device and for a Server

(71) Applicant: Bayerische Motoren Werke Aktiengesellschaft, Munich (DE)

(72) Inventors: Wangsu HU, Chicago, IL (US); Won TCHOI, Barrington, IL (US); Jilei TIAN, Chicago, IL (US); Marko WERNER, Chicago, IL (US)

(21) Appl. No.: 16/942,882

(22) Filed: Jul. 30, 2020

(51) Int. Cl. G06F 3/16; G06F 40/40; G06F 16/332

(52) U.S. Cl. CPC G06F 3/167; G06F 16/3329; G06F 40/40

(57) ABSTRACT

Examples relate to apparatuses, methods and computer programs for a user device and for a server, e.g. to provide a personalized service enabled by converting human language to processing logic. An apparatus for a user device comprises processing circuitry configured to obtain a user command from the user via a user interface of the user device, the user command being obtained in natural language. The processing circuitry is configured to provide the user command in natural language to the server via an interface. The processing circuitry is configured to obtain a response to the user command from the server via the interface, the response to the user command comprising an identifier that is assigned to the user command by the server. The processing circuitry is configured to assign the user command to an element of a graphical user interface of an application being executed by the user device, and to link the identifier to the element of the graphical user interface. For example, the element of the graphical user interface may be linked with processing logic generated by the server, which may be executed by the server (e.g. on data that is available on the server) or by the user device itself (e.g. on data available at the user device, or using data from a third-party service).

### FIELD

Examples relate to apparatuses, methods and computer programs for a user device and for a server, e.g. to provide a personalized service enabled by converting human language to processing logic.

### BACKGROUND

Applications are widely developed and used along with the booming of digital mobility services and ecosystems. Such apps, however, bring the consumer value by providing the services and features predefined by the developers (i.e. all the contributors among the app development). Such apps may cover the most important features app developers have decided upon, e.g. based on user study and market feedback. In reality, there may always be a gap between features offered by developers and features desired by consumers, due to a variety of needs even for the same feature among the consumers, bias in the decision, and long tail needs. It is a contradictory challenge that each consumer may only uses small part of features in the app, whereas the app may have a lots features being able to address the needs from the most consumers, thus making the app hard to develop, maintain and use.

In general, information available in a service database may be rich, but accessible only by a limited API logic, which may lead to inefficiency. Theoretically speaking, consumers have a variety of needs, and designer might only prioritize and then address the key features. For non-key features such as long tail or personal needs, such features might not be well-covered, reduce the consumer and business values that can be achieved on aggregate. Different users may have different expectation for the features. For example, someone may want to see a monthly refueling report, and others may be more interested to see a daily trip summary.

The app architecture and development process of many apps comprises one or more of the following aspects: (1) Design of the features and experience, (2) Backend implements APIs (Application Programming Interfaces) to enable predefined features and experience, (3) App implements UI (User Interface and Interaction) and business logic as defined by UX, and leverages the API from the backend as specified, (4) Publish the app and users download and install the app, and use it following the instruction for whatever features user needs, and (5) Users have too much limitation to customize the features what they want. The common way might be to give feedback, and hope the developers can address this expectation and release an upgraded app, but for all of the users, rather than individual users.

It may be challenging to select and prioritize the features due to the bias from data and mind of the decision-maker. There might not be a good way to address long tail features, which find little usage among all users, but a big impact when combining a large number of long tail features.

If the features are predefined, the feature set may be limited, otherwise it may be hard for both developers to manage, and consumer to recognize or use as users tend to dislike using complex apps with a steep learning curve due to many options. If the features are limited, feature prioritization may be challenging, and e.g. addressed by decision making that is based on market and consumer feedback. It may be questionable, whether the needs of all customers may be addressed.

There are mobile mashup applications, such as Android mashup, IBM mashup center, iPhone app wizard, that discover and combine the predefined web service APIs (Application Programming Interfaces), and connect them according to personal needs. These concepts, however, cannot customize the information if it is not predefined in the available rigid APIs, though the data may be available in the database.

### SUMMARY

Various examples of the present disclosure are based on the finding, that the functionality of software is caught in a balancing act between providing simplicity (by limiting the functionality to the essentials) and providing features desired by the users. Various examples of the present approach pursue an approach, in which a server is used to generate processing logic in response to a natural user command by a user. This processing logic can be referenced in a user-defined user interface of a user device, thus providing the user with an easy and intuitive way of extending the functionality of the user device, without overly adding complexity to the device. For example, one of the most popular applications is the search provided by the Google search engine, through which users are able to access vast amount of information, but through plain text or nearly no visual user interface. Such an access can be codified by using natural language to define the information being requested or command being issued, and linking the user command to a user interface. For example, the graphic user interface (GUI) can be made or edited by user directly with supported tooling, or shared from others in a personal app store managed, e.g. by app developers. This also enables new way of “ecosystem” to motivate user-generated content and micro-transactions for developers, rather than a model that is fully under control of the provider of the app ecosystem. In general, the user device may be any device being used (directly) by a user, such as a mobile device (e.g. a smartphone, tablet device, smart TV or laptop computer) or a desktop device (such as a desktop computer, a desktop appliance) or a home automation system.

Various examples of the present disclosure provide an apparatus for a user device. The apparatus comprises processing circuitry configured to obtain a user command from the user via a user interface of the user device. The user command is obtained in natural language. The processing circuitry is configured to provide the user command in natural language to the server via an interface. The processing circuitry is configured to obtain a response to the user command from the server via the interface. The response to the user command comprises an identifier that is assigned to the user command by the server. The processing circuitry is configured to assign the user command to an element of a graphical user interface of an application being executed by the user device, and to link the identifier to the element of the graphical user interface. By obtaining the user command using natural language, even end users are enabled to generate their own functionality. This functionality is codified by the server with corresponding processing logic, and the user-generated user interface is linked to that processing logic in order to have easy access to the user-generated functionality.

In various examples, the processing circuitry is configured to obtain the user command via a microphone of the user device. In other words, the user command may be obtained via spoken language. Accordingly, the user command may be provided to the server as a transcribed version of the user command (e.g. transcribed locally using on-device transcription) or a sound recording of the user command.

In various examples, the response comprises graphical or textual information. The processing circuitry may be configured to display the graphical or textual information of the response using the element of the graphical user interface. In other words, elements of the graphical user interface may be filled with the graphical or textual information retrieved from the server.

For example, the processing circuitry may be configured to generate the element of the graphical user interface upon request of the user. In other words, the user may create the user interface.

For example, the processing circuitry may be configured to select a graphical user element among a plurality of available graphical user elements based on the response by the server. For example, the processing circuitry may be configured to propose a graphical user element that is suitable for the content of the response.

The apparatus according to claim 1, wherein the response comprises, if the user command pertains to a functionality of the user device or to information being stored on the user device, processing logic for controlling the functionality of the user device or processing logic for processing the information being stored on the user device. The processing circuitry may be configured to link the element of the user interface with said processing logic.

In some examples, the response comprises, if the user command pertains to a functionality of a third-party service or to information being provided by the third-party service, processing logic for controlling the functionality of the third-party service or processing logic for processing the information being provided by the third-party service. The processing circuitry may be configured to link the element of the user interface with said processing logic. For example, the processing logic may be executed by the processing circuitry of the user device.

Various examples of the present disclosure relate to an apparatus for a server. The apparatus comprises processing circuitry configured to obtain a user command in natural language from a user device (e.g. via an interface). The processing circuitry is configured to decode the user command using natural language processing. The processing circuitry is configured to generate processing logic suitable for handling the user command based on the decoded user command. The processing circuitry is configured to assign an identifier to the user command. The processing circuitry is configured to provide a response to the user device. The response comprises the identifier assigned to the user command and one of graphical or textual information generated by the server using the processing logic in response to the user command, and the processing logic. In other words, the server may decode the user command and generate suitable processing logic for handling the user command. This processing logic is preserved, so the user can subsequently access the same functionality without having to re-specify the user command, e.g. by linked the user identifier and/or the processing logic to a user interface element of a user interface of an application being executed by the user device.

In various examples, the response comprises the graphical or textual information generated by the server using the processing logic in response to the user command. The processing circuitry may be configured to generate the graphical or textual information using the processing logic. The graphical or textual information may be used by the user device to populate user interface elements.

For example, the processing logic may comprise one or more commands for generating the graphical or textual information using information stored in at least one database of the server. Accordingly, the processing logic may be performed by the server to generate the graphical or textual information.

In some examples, the response comprises the processing logic. The processing logic may comprise one or more commands for generating a response to the user request using information provided by the user device and/or information provided by a third-party service. In this case, the processing logic may be executed by the user device.

In various examples, the processing logic is formulated using a structured query language (SQL)-based syntax. For example, the SQL-based syntax may be used to retrieve information from one or more databases.

Various examples of the present disclosure relate to a method for a user device. The method comprises obtaining a user command from the user via a user interface of the user device. The user command is obtained in natural language. The method comprises providing the user command in natural language to the server via an interface. The method comprises obtaining a response to the user command from the server via the interface. The response to the user command comprises an identifier that is assigned to the user command by the server. The method comprises assigning the user command to an element of a graphical user interface of an application being executed by the user device. The element of the graphical user interface is linked to the identifier.

Various examples of the present disclosure further provide a machine-readable storage medium including program code, when executed, to cause a machine to perform a method for a user device. The method comprises obtaining a user command from the user via a user interface of the user device. The user command is obtained in natural language. The method comprises providing the user command in natural language to the server via an interface. The method comprises obtaining a response to the user command from the server via the interface. The response to the user command comprises an identifier that is assigned to the user command by the server. The method comprises assigning the user command to an element of a graphical user interface of an application being executed by the user device. The element of the graphical user interface is linked to the identifier.

Various examples of the present disclosure provide a method for a server. The method comprises obtaining a user command in natural language from a user device. The method comprises decoding the user command using natural language processing. The method comprises generating processing logic suitable for handling the user command based on the decoded user command. The method comprises assigning an identifier to the user command. The method comprises providing a response to the user device, the response comprising the identifier assigned to the user command and one of graphical or textual information generated by the server using the processing logic in response to the user command, and the processing logic.

Various examples of the present disclosure further provide a machine-readable storage medium including program code, when executed, to cause a machine to perform a method for a server. The method comprises obtaining a user command in natural language from a user device. The method comprises decoding the user command using natural language processing. The method comprises generating processing logic suitable for handling the user command based on the decoded user command. The method comprises assigning an identifier to the user command. The method comprises providing a response to the user device, the response comprising the identifier assigned to the user command and one of graphical or textual information generated by the server using the processing logic in response to the user command, and the processing logic.

### BRIEF DESCRIPTION OF THE FIGURES

Some examples of apparatuses and/or methods will be described in the following by way of example only, and with reference to the accompanying figures, in which

FIG. 1a shows a block diagram of an example of an apparatus for a user device;

FIG. 1b shows a flow chart of an example of a method for a user device;

FIG. 2a shows a block diagram of an example of an apparatus for a server;

FIG. 2b shows a flow chart of an example of a method for a server;

FIG. 3 shows a schematic diagram of an example of an app architecture;

FIG. 4 shows a schematic diagram of an example of an architecture of a personal app;

FIG. 5 shows a schematic diagram of a visualization implemented using a UI component library;

FIG. 6 shows a schematic illustration of a customizable UT; and

FIG. 7 shows a schematic diagram of an example of semantic parsing being performed by a natural language interface.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an ‘or’, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

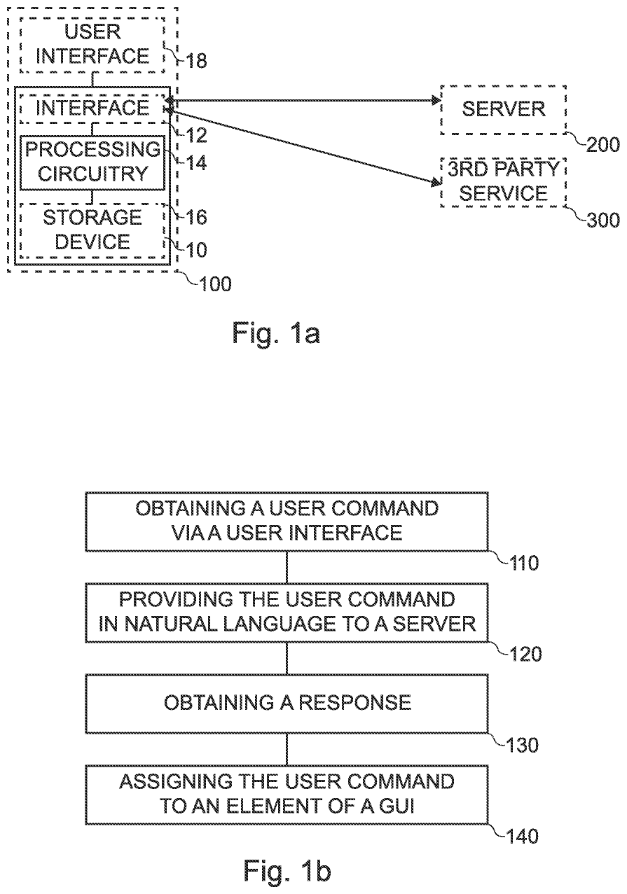

FIG. 1a shows a block diagram of an example of an apparatus 10 for a user device 100. The user device comprises processing circuitry 14 and an interface 12. Optionally, the apparatus further comprises one or more storage devices 16. The processing circuitry is coupled with the interface 12 and the optional one or more storage devices 16. In general, the functionality of the apparatus is provided by the processing circuitry, e.g. in conjunction with the interface and/or the one or more storage devices. FIG. 1a further shows the user device 100 comprising the apparatus 10, and a user interface 18 of the user device.

The processing circuitry is configured to obtain a user command from the user via the user interface 18 of the user device. The user command is obtained in natural language. The processing circuitry is configured to provide the user command in natural language to the server via an interface. The processing circuitry is configured to obtain a response to the user command from the server via the interface. The response to the user command comprises an identifier that is assigned to the user command by the server. The processing circuitry is configured to assign the user command to an element of a graphical user interface of an application being executed by the user device, and to link the identifier to the element of the graphical user interface.

FIG. 1b shows a flow chart of an example of a corresponding method for the user device. The method comprises obtaining the user command from the user via the user interface of the user device. The method comprises providing the user command in natural language to the server via an interface. The method comprises obtaining the response to the user command from the server via the interface. The method comprises assigning the user command to an element of the graphical user interface of the application being executed by the user device. Examples further provide a corresponding computer program, e.g. a machine-readable storage medium including program code, when executed, to cause a machine to perform a method for the user device.

The following description relates to the apparatus of FIG. 1a and to the corresponding method and computer program of FIG. 1b. Features of the apparatus, e.g. of the processing circuitry of the apparatus of FIG. 1a, may be likewise applied to the method and computer program of FIG. 1b.

Various examples of the present disclosure relate to an apparatus, method and computer program for a user device. In this context, a user device may be a personal device, e.g. a device being used by a single user. For example, the user device may be a mobile device, such as a smartphone, a tablet computer, a laptop computer or a wearable (such as a smartwatch), or a stationary device, such as a desktop computer or a home automation panel. In general, the user device may be based on a computer architecture, and may comprise one or more processors (such as the processing circuitry) for executing application programs, such as the application program referenced above. In addition, the user device comprises one or more user interfaces, such as a microphone, a camera, a keyboard, a touchpad, a touchscreen and the like. In other words, the user interface 18 may be one of a microphone, a camera, a keyboard, a touchpad, a touchscreen and the like. For example, the user command may be obtained as sound recording via the microphone. The user device, e.g. the processing circuitry may be configured to transcribe the sound recording (e.g. locally on device) to obtain the user command, or the sound recording may be the user command, and the user command may be provided as sound recording to the server.

The user command is obtained in natural language. For example, the user command may comprise an actual natural language command, such as “start the navigation”, or a question, such as “how many miles have I driven in the past week?”. In some cases, the user command may reference a previous user command. For example, a first user command may enquire about a location, e.g. “where's the next refueling station”, and a second, subsequent command may reference the first command, e.g. “please take me there” or “how much of a deviation would that be?”. In general, the user command might not be limited to a specific syntax, although some keywords may lead to a better results in the generation of processing logic.

The processing circuitry is configured provide the user command in natural language to the server via an interface. As mentioned above, the user command may be provided as a sound recording to the server, or as a textual representation of the user command. For example, the interface may be an interface suitable for communicating via a network, such as the internet. For example, the user command may be provided to the server via the network/internet.

The processing circuitry is configured to obtain a response to the user command from the server via the interface. In general, the response may be received in response to the provided user command, i.e. the response may relate to the provided user command. The response to the user command comprises at least an identifier that is assigned to the user command by the server. In general, the user command may be used to reference the user command, e.g. locally on the user device and/or at the server. For example, the identifier may be linked to an identifier of the user device or of the user of the user device. In general, the identifier may be used to re-execute the user command, e.g. at the server, or locally on the user device. In some examples, e.g. if the user command is to be executed by the user device, the response may comprise processing logic that relates to the user command, e.g. processing logic to perform the user command. For example, in some cases, e.g. if the user command relates to a question, the processing logic may be suitable for retrieving information from a data source, e.g. an API or a database. In this case, the processing logic may be in a SQL-like instruction language. In some cases, the user command may relate to the execution of a functionality. In this case, the processing logic may be formulated in a scripting language, e.g. in the Python scripting language.

The processing circuitry is configured to assign the user command to an element of the graphical user interface of the application being executed by the user device. For example, the application may be a companion application for a vehicle, e.g. a mobility application to remotely control some aspects of the vehicle. Alternatively, the application may be any application with a server component, e.g. a smart home application, or a personalized server-based service. The application may be re-configurable, i.e. the user may create or adapt user interface elements, and link them with the user commands. For example, the processing circuitry may be configured to generate the element of the graphical user interface upon request of the user. In other words, the application may provide the user with the ability of creating an additional user interface element, or of adapting an existing user interface element. For example, the processing circuitry is configured to select a graphical user element among a plurality of available graphical user elements based on the response by the server. The processing circuitry is configured to link the identifier of the user command to the element of the graphical user interface. By linking the identifier to the element of the graphical user interface, the respective user command may be performed to populate the element of the user interface, or, if the user element is a button, the user command may be performed when the button is actuated. For example, the element of the user interface may be a user element for displaying information, e.g. a label, a table, or a graphics frame, or a user element for actuation, e.g. button.

For example, the response may comprise graphical or textual information. The processing circuitry may be configured to display the graphical or textual information of the response using the element of the graphical user interface. In other words, the processing circuitry may be configured to populate the element of the user interface with the graphical or textual information comprised in the response.

In some cases, the user command relates to functionality being provided by the user device itself, or to a functionality being provided by a third-party service, or to information available at the user device or from the third-party service. In this case, the response may comprise the actual processing logic, to be executed by the user device. In other words, the response may comprise, if the user command pertains to a functionality of the user device or to information being stored on the user device, processing logic for controlling the functionality of the user device or processing logic for processing the information being stored on the user device. For example, the response may comprise, if the user command pertains to a functionality of a third-party service or to information being provided by the third-party service, processing logic for controlling the functionality of the third-party service or processing logic for processing the information being provided by the third-party service. The processing circuitry may be configured to link the element of the user interface with said processing logic (e.g. via the identifier).

The interface 12 may correspond to one or more inputs and/or outputs for receiving and/or transmitting information, which may be in digital (bit) values according to a specified code, within a module, between modules or between modules of different entities. For example, the interface 12 may comprise interface circuitry configured to receive and/or transmit information.

For example, the processing circuitry 14 may be implemented using one or more processing units, one or more processing devices, any means for processing, such as a processor, a computer or a programmable hardware component being operable with accordingly adapted software. In other words, the described function of the processing circuitry 14 may as well be implemented in software, which is then executed on one or more programmable hardware components. Such hardware components may comprise a general-purpose processor, a Digital Signal Processor (DSP), a micro-controller, etc.

In at least some examples, the one or more storage devices 16 may comprise at least one element of the group of a computer readable storage medium, such as an magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

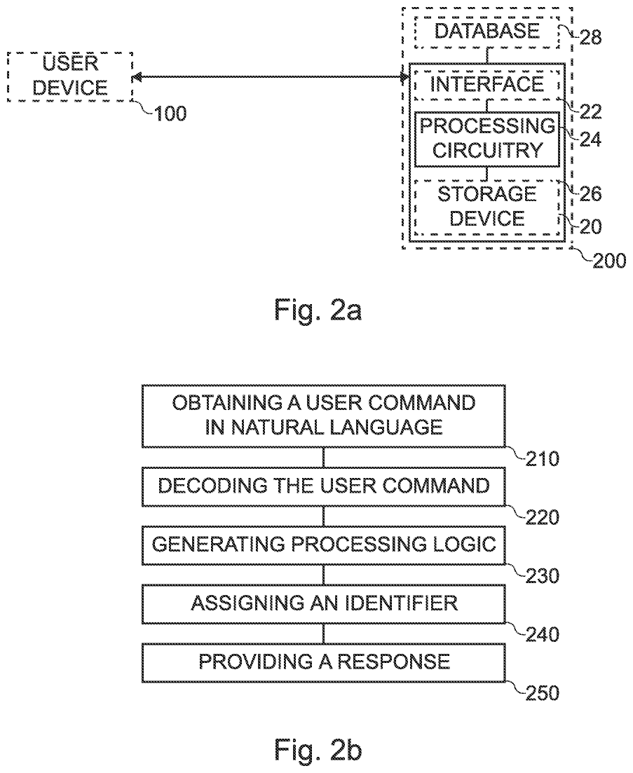

More details and aspects of the apparatus, method and computer program for the user device are mentioned in connection with the proposed concept or one or more examples described above or below (e.g. FIGS. 2a to 7). The apparatus, method and computer program for the user device may comprise one or more additional optional features corresponding to one or more aspects of the proposed concept or one or more examples described above or below.

FIG. 2a shows a block diagram of an example of an apparatus 20 for a server 200. The server comprises processing circuitry 24 and an interface 22. Optionally, the apparatus further comprises one or more storage devices 26. The processing circuitry is coupled with the interface and the optional one or more storage devices. In general, the functionality of the apparatus is provided by the processing circuitry, e.g. in conjunction with the interface and/or the one or more storage devices. FIG. 2a further shows the server 200 comprising the apparatus 20.

The processing circuitry is configured to obtain a user command in natural language from a user device. The processing circuitry is configured to decode the user command using natural language processing. The processing circuitry is configured to generate processing logic suitable for handling the user command based on the decoded user command. The processing circuitry is configured to assign an identifier to the user command. The processing circuitry is configured to provide a response to the user device. The response comprises the identifier assigned to the user command and the graphical or textual information generated by the server using the processing logic in response to the user command or the processing logic itself.

FIG. 2b shows a flow chart of an example of a corresponding method for the server. The method comprises obtaining the user command in natural language from the user device. The method comprises decoding the user command using natural language processing. The method comprises generating the processing logic suitable for handling the user command based on the decoded user command. The method comprises assigning the identifier to the user command. The method comprises providing the response to the user device. Various examples further relate to a computer program, e.g. a machine-readable storage medium including program code, when executed, to cause a machine to perform the method for the server.

The following description relates to the apparatus of FIG. 2a and to the corresponding method and computer program of FIG. 2b. Features of the apparatus, e.g. of the processing circuitry of the apparatus of FIG. 2a, may be likewise applied to the method and computer program of FIG. 2b.

While the examples presented in connection with FIGS. 1a and/or 1b relate to the user device, FIGS. 2a and/or 2b relate to an apparatus, method and computer program for the corresponding server. The user device and the server communicate, e.g. by exchanging the user command and the response. Accordingly, the respective examples given for the user command and the corresponding response in connection with FIGS. 1a and/or 1b may also be applied to the server of FIGS. 2a and/or 2b.

The processing circuitry is configured to obtain the user command in natural language from the user device, e.g. via the interface 22 of the apparatus. For example, the user command may be obtained (e.g. received) via a network, e.g. the interne. In some cases, the user command may be obtained in a textual representation. In some cases, however, the user command may be obtained as sound recording. In this case, the processing circuitry may be configured to transcribe the sound recording, e.g. using machine-learning, and/or using a functionality that is provided by a third-party service.

The processing circuitry is configured to decode the user command using natural language processing, and to generate the processing logic based on the decoded user command. In general, decoding the user command using natural language processing may comprise assigning meaning to the individual words of the user command, and extracting keywords (that are used to formulate the processing logic) from the user command. For example, machine-learning may be used to decode the user command. The processing circuitry is configured to generate the processing logic based on the decoded user command. For example, the processing logic may be configured to use the extracted keywords to construct the processing logic. For example, the processing logic may be formulated using a SQL-based syntax. The processing circuitry may be configured to formulate a SELECT-clause, a WHERE-clause, and optionally a FROM clause (e.g. when the information is retrieved from multiple tables or multiple databases) based on the decoded user command. For example, the processing circuitry may be configured to replace some of the keywords, e.g. time-based keywords or location-based keywords, with their objective counterparts, e.g. “today”, “tomorrow” or “last week” with the corresponding days or time spans, or “here” with the current location. In addition, the columns or data fields of APIs available from the server may be annotated, e.g. to provide a match even if the user does not utter the exact name of the respective column or data field.

In general, the decoding and the generation of the processing logic may be provided with using two different algorithms or computer programs, alternatively, a joint algorithm or computer program may be used to decode the user command, and to generate the corresponding processing logic. For example, the processing circuitry may be configured to employ a framework for converting the user command into the processing logic, e.g. the SQLova framework, the NL2SQL framework, the Seq2SQL framework or the HydraNet framework. Alternatively, the processing logic may be formulated in a scripting language, such as Python. In this case, the processing circuitry may be configured to use a suitable for converting the user command into a scripting-language based processing logic. In both cases, the processing logic is suitable for handling the user command. For example, if the user command is an actual command, the processing logic may be based on a scripting language, in order to trigger one or more commands associated with the user command. If the user command is a question, the processing logic may be based on a SQL-based syntax. In this case, the user command may be a command to provide certain information from an information source, such as an API or database.

The processing circuitry is configured to assign an identifier to the user command. In general, the identifier may be a random or pseudo-random identifier. In some cases, the identifier may be linked to a user identifier of a user of the user device or of the user device.

The processing circuitry is configured to provide the response to the user device, e.g. via the interface 22. The response comprises the identifier assigned to the user command (e.g. so the user device can access the user command at the server via the identifier).

For example, the response may comprise the graphical or textual information generated by the server using the processing logic in response to the user command. Accordingly, the processing circuitry may be configured to generate the graphical or textual information using the processing logic. For example, the processing logic may comprise one or more commands for generating the graphical or textual information using information stored in at least one database of the server. After the response has been provided to the user device, the user device may repeat the user command by transmitting the identifier to the server, and the apparatus may be configured to provide the graphical or textual information generated by the server using the processing logic in response to the user command in response to the received identifier, e.g. without requiring re-transmission of the user command.

In some cases, the processing logic may be executed by the user device. In this case, the response may comprise the processing logic itself. Accordingly, the processing logic may comprise one or more commands for generating a response to the user request using information provided by the user device and/or information provided by a third-party service.

The interface 22 may correspond to one or more inputs and/or outputs for receiving and/or transmitting information, which may be in digital (bit) values according to a specified code, within a module, between modules or between modules of different entities. For example, the interface 22 may comprise interface circuitry configured to receive and/or transmit information.

For example, the processing circuitry 24 may be implemented using one or more processing units, one or more processing devices, any means for processing, such as a processor, a computer or a programmable hardware component being operable with accordingly adapted software. In other words, the described function of the processing circuitry 24 may as well be implemented in software, which is then executed on one or more programmable hardware components. Such hardware components may comprise a general-purpose processor, a Digital Signal Processor (DSP), a micro-controller, etc.

In at least some examples, the one or more storage devices 26 may comprise at least one element of the group of a computer readable storage medium, such as an magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus, method and computer program for the server are mentioned in connection with the proposed concept or one or more examples described above or below (e.g. FIG. 1a to 1b, 3 to 7). The apparatus, method and computer program for the server may comprise one or more additional optional features corresponding to one or more aspects of the proposed concept or one or more examples described above or below.

Various examples relate to a personal app experience enabled by a natural interface, e.g. to a personal or personalized app, with app features that can be customized by the user on their own, by leveraging enabling technologies and human ways to interact with the information provided by service APIs (Application Programming Interfaces). In the context of the present disclosure, a novel approach is proposed that may allow users to flexibly customize their application and UX (user experience) on their own, intuitively and manageable using a natural language interface. Additionally, these concepts have no natural interface neither.

Various examples of the present disclosure may be applied by internet service companies who provide developer platforms for app ecosystems, and by automotive companies who actively bring smart and personal digital services through an app.

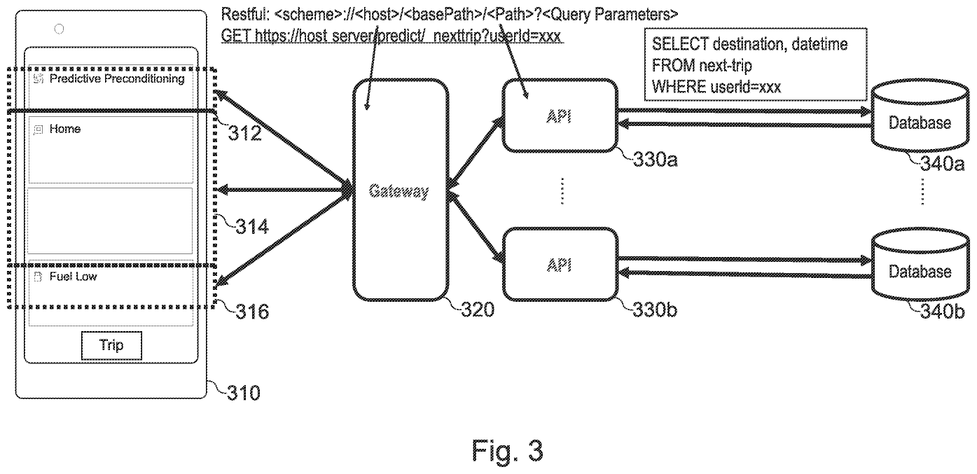

FIG. 3 shows a schematic diagram of an example of an app architecture. FIG. 3 shows a UI (user interface) 310 on a smartphone, with various sections 312 (a section relating to predictive preconditioning), 314 (a section comprising subsections relating to various trips, such as a trip home (with estimated time required, estimated time of arrival, number of miles), or a trip from a first location to a second location (with a trip history of the trip), and 316 (a section comprising information on the vehicle, such as “low fuel”, with an option to find a location for refueling). The information displayed in the UI is provided by a gateway 320, e.g. in response to a command that is received via an API. In FIG. 3, a restful API is used, with the syntax: <scheme>://<host>/<basePath>/<Path>?<Query Parameters> (e.g. GET https://host server/predict/nexttrip?userId=xxx). The gateway gathers the required information via APIs 330a; 330b, which in turn formulate database queries (such as SELECT destination, datetime, from next-trip, where usedId=xxx) to retrieve the information of interest from database servers 340a, 340b (with each API being linked to a database server). In this case, a predefined UI and customized API is used. The API may include the service offered by the backend and device itself. It can retrieve the information for rendering, and execute the action. This may have the advantage of a native UX and ease-of-use, but may provide less flexibility are predefined by the developers, rather than the users. Information in the database might not be efficiently used due to access limitations imposed by the API logic.

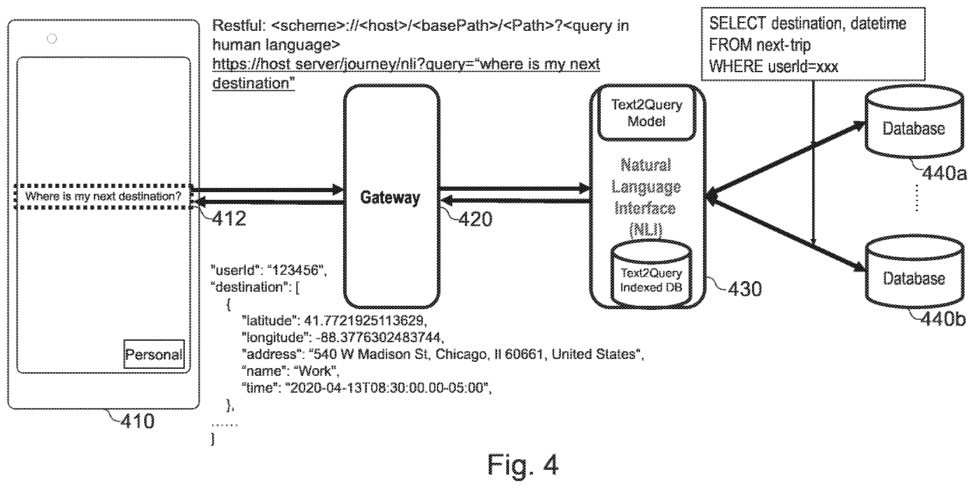

FIG. 4 shows a schematic diagram of an example of an architecture of a personal app. FIG. 4 shows an UI 410 that is shown on a user device, such as a smartphone. In this example, a question/user command in input as natural language, in this case “Where is my next destination?”. The question is provided to a gateway 420 via natural language. Again, a restful API is used, with the syntax: “<scheme>://<host>/<basePath>/<Path>?<query in human language>”, which results in the user command “https://host server/journey/nli?query=”where is my next destination“. The query is provided to a natural language interface (NLI) 430, with a Text2Query model and a Text2Query indexed DB. The NLI generates the processing logic to formulate the database query, and executes the database query (in this case “SELECT destination, datetime FROM next-trip WHERE userId=xxx”) to retrieve the information (from database 440b of databases 440a; 440b). The “userld” and the “destination” (e.g. latitude, longitude, address, name and time”) may be returned to the UI (via the gateway). Using this approach, the users may be able to customize the features on their own. For example, the following user commands/questions may be answered: “Where is my next destination?”, “Show me all my planned trips today?”, “Please list my trips for the upcoming week?”, etc.

Key enables of such a system may be the visualization in the UI (on the user device), and a semantic parsing algorithm.

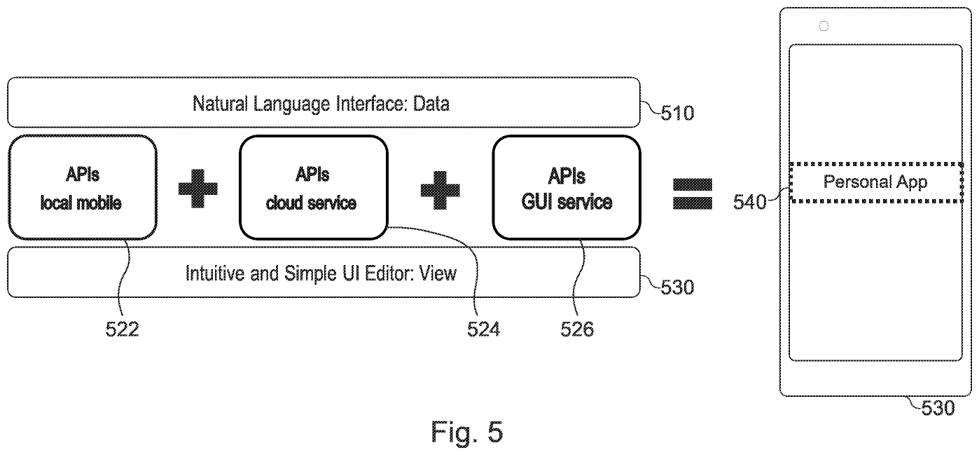

FIG. 5 shows a schematic diagram of a visualization implemented using a UI component library. The data is provided by a natural language interface 510, while the view is provided by an intuitive and simple UI editor 530. The NLI may provide a flexible API interface, which may enrich API semantics of existing APIs via a web service description language. APIs locally provided by the mobile device 522, by a cloud service 524 and by a GUI (Graphical User Interface) service are used together with the NLI and the UI editor to provide the personal app, that is displayed on the user device (smartphone). Customized UIs that are sharable within a community have been used in business intelligence tooling, such as Grafana or Power BI.

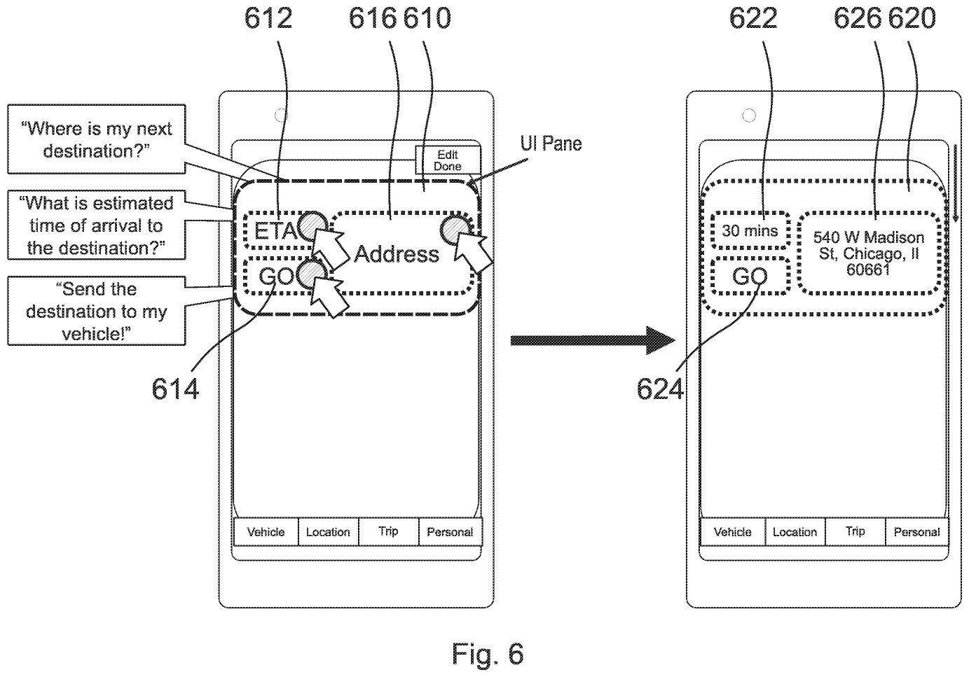

FIG. 6 shows a schematic illustration of a customizable UI. On the left, a mode for customizing the UI layout is shown, in which the UI can be customized, and then the associated function can be assigned by NLI. FIG. 6 shows a UI pane (a section of the UI) 610 of the UI, with three UI elements 612 (a label with the Estimated Time of Arrival, which may be generated in response to the question “what is the estimated time of arrival to the destination”), 614 (a “Go button” for sending the destination to the vehicle, which may be generated in response to the user command “send the destination to my vehicle”), and 616 (a label with the address of the next destination, which may be generated in response to the question “that is my next destination”). For example, the UI elements mat be linked to identifiers and corresponding processing logic generated by a server. On the right side of FIG. 6, the corresponding UI elements 622-626 of corresponding UI pane 620 are shown with data provided by a database. All variables may be shared in the plain, e.g. “destination” may be acquired from <Address>, but reused in <ETA> and <GO>. The used location may be access from an API of the local device, as default.

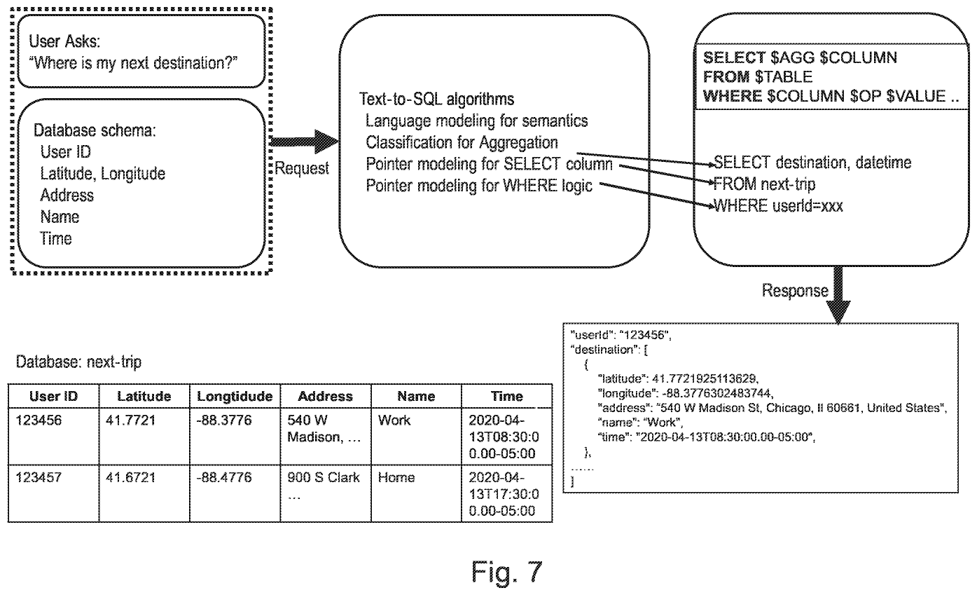

FIG. 7 shows a schematic diagram of an example of semantic parsing being performed by the natural language interface. A user may ask “Where is my next destination?”. This user command may, together with the database schema (User ID, Latitude/Longitude, Address, Name, Time), provided as a request to a text-to-SQL (Server Query Language) algorithm, which may provide language modeling for semantics, classification for aggregation (e.g. “SELECT destination, datetime”), pointer modeling for select column (e.g. “FROM trip”) and pointer model for the “WHERE” logic (e.g. “WHERE userId=xxx). The syntax for the schema may be SELECT $AGG (aggregator) $COLUMN FROM $TABLE WHERE $COLUMN $OP (operator) $VALUE . . . . The response may comprise the information introduced in connection with FIG. 4, e.g. retrieved from the database table (that conforms to the database schema referenced above) of database next-trip shown on the lower left of FIG. 7. In evaluations, the performance of such a Text-to-SQL exceeded 90%-

Various examples of the present disclosure relate to an advanced semantic parsing algorithm. Based on the semantic and NL2SQL (Natural Language to Server Query Language) two-layer architecture, various examples extend the semantic model with an enriched schema semantic representation, rather than just column names, that can enhance the encoder learning capability toward capturing the question-column relation in NL2SQL. Meanwhile, in the decoder, syntactic constraints may be considered, which may be vital for structured language generation such as SQL query translation. Various examples may enable multi-domain parsing and text normalization that address two issues found in existing NL2SQL frameworks. For example, various examples may provide a multi-table feature, where users are allowed to ask information from multiple tables or even databases. Additionally or alternatively, various examples may provide text normalization. Taking date-time as example, which is one of the most frequently used terms in user utterance, may be recognized and converted into the regular expression then parsed into the generated SQL query. For example, “today” may be transformed into the current date (e.g. “2020-04-20”), or “now” may be converted into the current time (e.g. “2020-04-13T08:30:00.00-05:00”).

Various examples provide a customizable app, which may allow users to customize the features on their own by leveraging natural language interface for dealing with APIs and intuitive UI generation just like “painting”, along the trend that users are able to leverage the tools to generate their personal contents for text, audio, image and video. For example, users can also simply download the UI created by others from the store, particularly for those who have personal need but do not want to create it by themselves.

Various examples may provide an improved personal consumer experience, where users are able to have a personal app that is different than others but provides features that the respective user desires. The app may be simple to use and exactly what the respective user wants. Normally, an app may be easy to use only with a small number of features, but hard to find what is exactly desired due to small number of selection or options.

Various examples may provide an improved development efficiency. Development may focus on the framework, and on a small number of key features and services, while spending less time on decision, selection, prioritization, design and development for the most and rest of features, and leave them for customers to address on their own by providing an intuitive and easy-to-use tooling and interface. The app may then be developed jointly by developers and consumers together.

Various examples may also enable monetization and new business models, as users may be able to share UI components, e.g. pane, created or edited by them, and publish them among the consumer community, thus enriching the app and service with more opportunities. Various examples may motivate users to jointly contribute and enrich the features in the app. It may be extended to build personal app completely and empower the ecosystem of platform providers, developers but also consumers.

In the following, some reference algorithm implementations on neural semantic parsing are introduced. In particular, the NL2SQL (Natural Language to Server Query Language) framework is introduced. NL2SQL may be used for the task of translating natural language to logic form—e.g. into meaningful executable queries (i.e. processing logic) such as SQL queries, and Python code. An exemplary NL2SQL workflow may be summarized as follows: User: {natural language utterance}→Agent: NL2SQL model→{SQL query}→Database →{query result}→Agent→User. Using, the NL2SQL framework, the question “Who is the player that wears No. 42” may be transformed into “SELECT Player WHERE No.=42” (from a table comprising the columns Player and No.).

The NLI, which may be implemented using NL2SQL, may be used to generate structured queries from natural language, to retrieve info from a database. For example, apart from NL2SQL, other NLIs are Seq2SQL, SQLova and HydraNet. In general, these frameworks may be used to formulate both the SELECT statement and the WHERE statement or statements (and, for example, the FROM statement, if multiple data sources are being considered).

In a reference implementation, SQLova was chosen. SQLova was evaluated by Hwang et al. in “A Comprehensive Exploration on WikiSQL with Table-Aware Word Contextualization”, and exceeded human performance by 1.3% in execution accuracy. SQLova used BERT-based table- and context-aware word-embedding, a sequence-to-SQL model leveraging recent works (Seq2SQL, SQLNet), sketch-based slot filling method for SQL generation and an embedding with token, segment and position, jointly encoding natural language query and schema. For example, SQL generation may be divided into six sub-tasks: (1) $select-column$: to find column in select clause by contextualizing question through column-attention mechanism, (2) $select-aggregation$: to find an aggregator among six given choices $(NONE, MAX, MIN, COUNT, SUM, AVG)$, (3) $where-number$ and $where-column$: to find the columns in the where clause, (4) $where-operator$ to find an operator among three given choices ${=, >, <})$ for a given column through column-attention and (6) $where-value$ to find the value token in the where clause by locating start- and end-tokens from the question for the predicted $where-column$ and $where-operator$.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An apparatus for a user device, the apparatus comprising processing circuitry configured to:
obtain a user command from a user via a user interface of the user device, the user command being obtained in natural language;
provide the user command in natural language to the server via an interface;
obtain a response to the user command from the server via the interface, the response to the user command comprising an identifier that is assigned to the user command by the server; and
assign the user command to an element of a graphical user interface of an application being executed by the user device, and to link the identifier to the element of the graphical user interface.

2. The apparatus according to claim 1, wherein the processing circuitry is configured to obtain the user command via a microphone of the user device.

3. The apparatus according to claim 1, wherein the response comprises graphical or textual information, wherein the processing circuitry is configured to display the graphical or textual information of the response using the element of the graphical user interface.

4. The apparatus according to claim 1, wherein the processing circuitry is configured to generate the element of the graphical user interface upon request of the user.

5. The apparatus according to claim 4, wherein the processing circuitry is configured to select a graphical user element among a plurality of available graphical user elements based on the response by the server.

6. The apparatus according to claim 1, wherein the response comprises, if the user command pertains to a functionality of the user device or to information being stored on the user device, processing logic for controlling the functionality of the user device or processing logic for processing the information being stored on the user device, wherein the processing circuitry is configured to link the element of the user interface with said processing logic.

7. The apparatus according to claim 1, wherein the response comprises, if the user command pertains to a functionality of a third-party service or to information being provided by the third-party service, processing logic for controlling the functionality of the third-party service or processing logic for processing the information being provided by the third-party service, wherein the processing circuitry is configured to link the element of the user interface with said processing logic.

8. An apparatus for a server, the apparatus comprising processing circuitry configured to:
obtain a user command in natural language from a user device;
decode the user command using natural language processing;
generate processing logic suitable for handling the user command based on the decoded user command;
assign an identifier to the user command; and
provide a response to the user device, the response comprising the identifier assigned to the user command and one of:
a) graphical or textual information generated by the server using the processing logic in response to the user command; and
b) the processing logic.

9. The apparatus according to claim 8, wherein the response comprises the graphical or textual information generated by the server using the processing logic in response to the user command, the processing circuitry being configured to generate the graphical or textual information using the processing logic.

10. The apparatus according to claim 9, wherein the processing logic comprises one or more commands for generating the graphical or textual information using information stored in at least one database of the server.

11. The apparatus according to claim 8, wherein the response comprises the processing logic, wherein the processing logic comprises one or more commands for generating a response to the user request using information provided by the user device and/or information provided by a third-party service.

12. The apparatus according to claim 8, wherein the processing logic is formulated using a server query language-based syntax.

13. A non-transitory, machine-readable storage medium including program code, when executed, to cause a machine to perform a method for a user device, the method comprising:
obtaining a user command from a user via a user interface of the user device, the user command being obtained in natural language;
providing the user command in natural language to the server via an interface;
obtaining a response to the user command from the server via the interface, the response to the user command comprising an identifier that is assigned to the user command by the server; and
assigning the user command to an element of a graphical user interface of an application being executed by the user device, the element of the graphical user interface being linked to the identifier.
